(19) United States
(12) Patent Application Publication
(10) Pub. No.: US 2005/0182631 A1
(43) Pub. Date: Aug. 18, 2005

(54) Voice message recording and playing method using voice recognition

(76) Inventors: In-Seok Lee, Seoul (KR); Kyu-Woong Hwang, Seoul (KR); Sun-Tae Kim, Seoul (KR)

Correspondence Address: RABIN & Berdo, PC, 1101 14TH STREET, NW, SUITE 500, WASHINGTON, DC, 20005, US

(21) Appl. No.: 10/785,228

(22) Filed: Feb. 25, 2004

(30) Foreign Application Priority Data
Feb. 13, 2004 (KR) 2004-0009720

(51) Int. Cl. G10L 11/00

(52) U.S. Cl. 704/275

(57) ABSTRACT

Disclosed is a voice message recording/playing method using voice recognition in which if a user's voice command is inputted through a microphone in a voice recognition mode selected by a function selection key, voice is recognized and then a preset command is performed correspondingly to the inputted voice command, the method including the steps of: selecting a set mode using the function selection key; if a system is in a system-on state in the mode selecting step, sequentially issuing a voice command whenever the function selection key is pressed; if a record mode is selected in the mode selecting step, recording a user's voice message corresponding to a pre-stored voice command in a data memory according to a guidance message; if a voice recognition standby mode is selected in the mode selecting step, recognizing the inputted user's voice command to detect a corresponding voice message from the data memory and voice the detected voice message through a speaker; and if the voice command is not inputted for a predetermined period after the function selection key is pressed, voicing a guidance message and concurrently, converting a current mode into a sleep mode.

### BACKGROUND OF THE INVENTION

1. Field of the Invention

The present invention relates to a voice recognition system, and more particularly, to a voice message recording and playing method using voice recognition in which a user directly records a voice message in a memory of a voice message recording/playing device installed in a toy, a picture frame, and a car and the like, and then the recorded voice message is accessed and voiced at the time of a user's voice command.

2. Description of the Related Art

Generally, a conventional toy is constructed to perform a predetermined operation using a driving device such as a motor and the like. The toy performs an operation of a set function according to a user's selection.

In the toy, the user selects the set function by manipulating a switch and the like provided for the toy. Together with this, the toy includes a voice recognition function to operate depending on a user's voice command.

The toy operating by voice recognition is disclosed in Korean Patent No.: 1003309090000 entitled “CONTROLLING METHOD OF TOY'S OPERATION USING PATTERN RECOGNITION OF SOUND OR VOICE”.

FIG. 1 is a flowchart illustrating a conventional controlling method of a toy's operation using pattern recognition, and illustrates a procedure of setting an operation command depending on sounds of video contents and storing a specific pattern of a corresponding sound, and a procedure of recognizing the set and stored sound pattern at the sounds outputted at the time of broadcasting and playing a mobile image on TV, and executing the operation command depending on the recognized sound pattern through the toy.

In the conventional controlling method of the toy's operation using the pattern recognition of FIG. 1, the operation command is set when video contents are manufactured and a feature of a sound pattern corresponding to the set operation command is extracted and stored (S301), and then the most similar sound pattern with the sound pattern that is stored at the time of manufacturing is detected from the sound outputted at the time of broadcasting or playing the video contents to allow the operation command depending on the detected sound pattern to be executed through the toy (S302).

Herein, when the video contents are manufactured, the toy is constructed to have the corresponding sound and the operation command depending on the sound by preparing a series of scenarios for defining the sound and a period depending on the sound such that the toy performs its relation operation at an appropriate time at the time of broadcasting or playing.

By delaying the operation command for a predetermined period and then executing the delayed operation command when the toy's operation is performed, the sound existing at an appropriate time before an operation time can be set as an object sound for the command execution. For one example of the operation command, the operation command is constructed to allow several operation commands to be performed for one sound, and to have a set delay time before an operation command code. Accordingly, a pattern recognition process for the object sound can be reduced to the maximum.

In the conventional art, the operation command is defined to execute the operation related with the video contents through the toy at an appropriate time of playing or broadcasting the video contents, the object sound for executing the operation is set, and then the duration and the feature of the recognition pattern are extracted from the set sound and stored together with the operation command (S301). After that, a sound signal is received from the sound outputted at the time of broadcasting or playing the video contents, a sound duration is detected from the received sound signal, a duration and a feature for a pattern recognition are obtained from the detected sound duration, and then a similarity of the obtained feature with the previously stored feature is calculated to detect the most similar pattern from the patterns having a similarity of more than a certain similarity such that a corresponding operation command is executed through the toy (S302).

However, the conventional controlling method of the toy's operation using the pattern recognition has a drawback in that the toy is not responsive to the user's direct voice command, a cause cannot be explained in case of a failure of the voice recognition, a user's voice cannot be directly stored and changed since the sound or voice pattern outputted from a mass media such as TV set or video player is recognized, only the set operation is performed and only the pre-stored voice signal depending on the recognized pattern is outputted.

### SUMMARY OF THE INVENTION

Accordingly, the present invention is directed to a voice message recording and playing method using voice recognition that substantially obviates one or more problems due to limitations and disadvantages of the related art.

An object of the present invention is to provide a voice message recording and playing method using voice recognition in which a user directly stores a voice message, a voice command is recognized to allow the stored voice message to be voiced, and a cause of not recognizing the voice command is voiced to allow a user to exactly input the voice command.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a voice message recording/playing method using voice recognition in which if a user's voice command is inputted through a microphone in a voice recognition mode selected by a function selection key, voice is recognized and then a preset command is performed correspondingly to the inputted voice command, the method including the steps of: selecting one of preset modes as the function selection key is pressed; if a system is in a system-on state in the mode selecting step, sequentially issuing a voice command whenever the function selection key is pressed; if a record mode is selected in the mode selecting step, recording a user's voice message corresponding to a pre-stored voice command in a data memory according to a guidance message; if a voice recognition standby mode is selected in the mode selecting step, recognizing the inputted user's voice command to detect a corresponding voice message from the data memory and voice the detected voice message through a speaker; and if the voice command is not inputted for a predetermined period after the function selection key is pressed, voicing a guidance message and concurrently, converting a current mode into a sleep mode.

The recording step includes: a first step of if the message key is pressed for record in a record standby mode, recording a voice message according to a record guidance message; a second step of if a length and a sound amount of the inputted voice message is not within a predetermined range, voicing a guidance message requesting a user to again input; and a third step of if the length and the sound amount of the inputted voice message is within the predetermined range, storing the voice message in the data memory.

The voice recognizing/voicing step includes: a first step of recognizing the user's voice command in the voice recognition standby mode to detect and voice a corresponding voice message from the data memory, and returning to the voice recognition standby mode; a second step of if a length and a sound amount of the voice command is not within a recognition range as a result of user's voice recognition, voicing a guidance message for the recognition result and then returning to the voice recognition standby mode; and a third step of if the voice command is not a pre-stored command as a result of the user's voice recognition, voicing a corresponding guidance message and then returning to the voice recognition standby mode.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a flowchart illustrating a conventional controlling procedure of a toy's operation using pattern recognition;

FIG. 2 is a block diagram illustrating a voice message recording/playing device for embodying a voice message recording and playing method using voice recognition according to a preferred embodiment of the present invention;

FIG. 3 is a flowchart illustrating a voice message recording and playing method using voice recognition according to a preferred embodiment of the present invention;

FIG. 4 is a detailed flowchart illustrating a voice message recording procedure in FIG. 3; and

FIG. 5 is a detailed flowchart illustrating a voice message playing procedure according to voice recognition in FIG. 3.

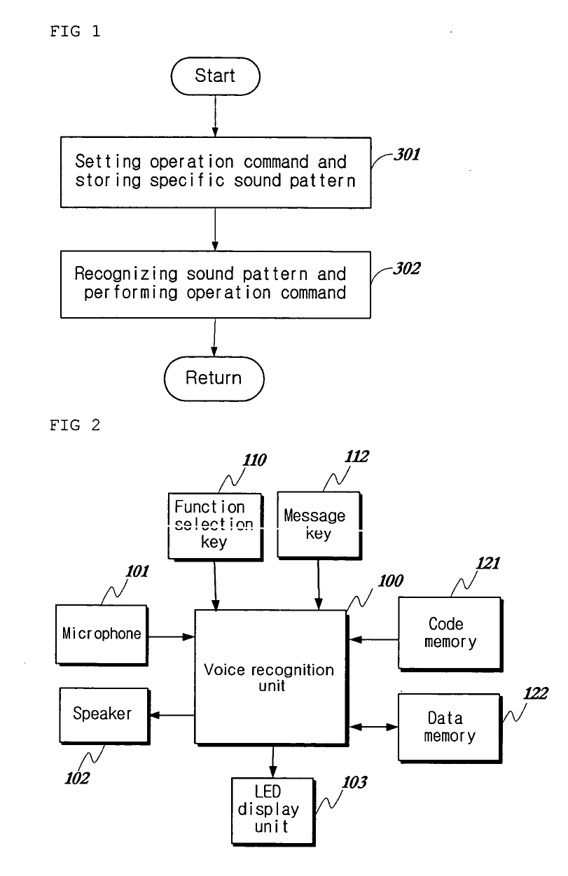

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

FIG. 2 is a block diagram illustrating a voice message recording/playing device using voice recognition according to a preferred embodiment of the present invention.

The voice message recording/playing device includes a microphone 101 for inputting a user's voice message; a speaker 102 for voicing a recorded voice message and a pre-stored guidance message; a LED (Light Emitting Diode) displaying unit 103 for displaying an operation state and mode of a voice recognition unit 100; a function selection key 110 for selecting a function and a mode; a message key 112 for recording and playing the voice message; a code memory 121 for storing a voice recognition algorithm, a voice model for a word/sentence, and a pre-recorded guidance message and the like; and a data memory 122 for storing a user's voice message.

Herein, as a dedicated chip having a sound card and a voice recognition function for voice recognition, the voice recognition unit 100 allows the voice message to be inputted and voiced through an embedded AD CODEC, and allows the voice model to be extracted, operated and stored from the inputted voice message by a program and the voice recognition algorithm.

An operation of the above-constructed recording/playing device is in detail described with reference to FIGS. 2 to 5 as follows.

First of all, the recording/playing device according to the present invention is installed in a doll, a picture frame, a card and the like to allow the voice message directly stored by a user to be voiced in case that other persons issue a voice command.

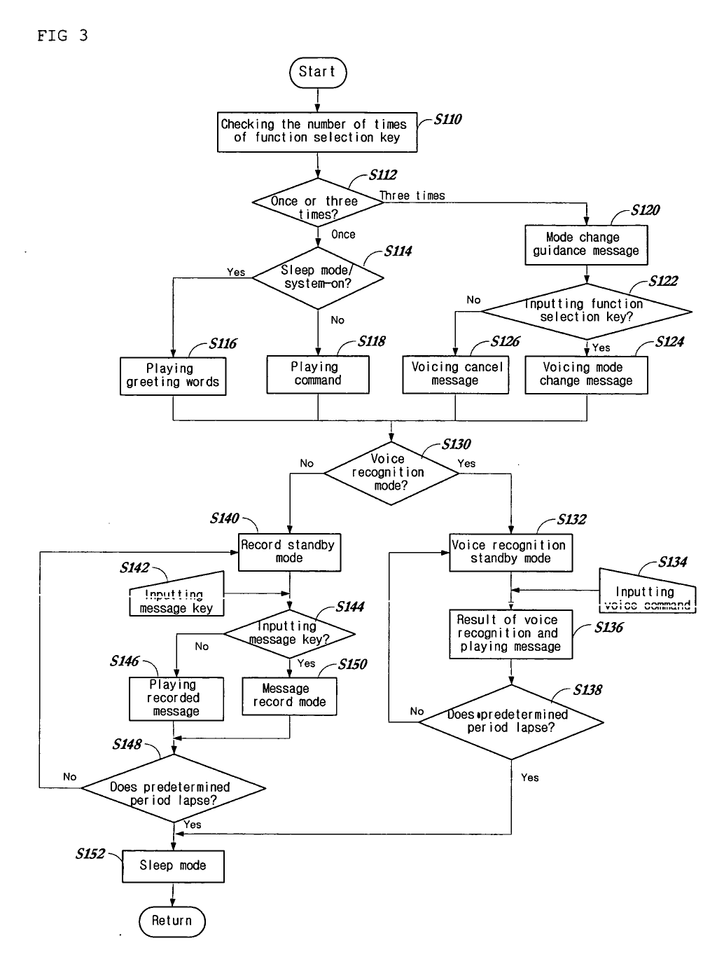

FIG. 3 is a flowchart illustrating a voice message recording and playing method using voice recognition according to a preferred embodiment of the present invention.

In case the user presses the function selection key 110, the voice recognition unit 100 first checks pressing times of the function selection key 110 at a predetermined interval (S110).

If the function selection key 110 is pressed once as preset, a state of a system is checked. If the system is in a sleep mode or in a power-off state, the sleep mode is turned off or the system is turned on and then the LED display unit 103 is turned on (S112 to S116).

If the function selection key 110 is pressed once in the system-on state, the voice recognition unit 100 senses the once pressing of the function selection key 110, detects and plays the voice commands pre-stored in the data memory 122 (for example, “I love you”, “I want to see you”, “Kiss me”, “Sing a song”, “Thank you”, “Bad guy, “Dream me” and the like) to allow the played voice commands to be outputted through the speaker 102 (S118).

Meanwhile, if the pressing times of the function selection key 110 detected by the voice recognition unit 100 corresponds to a mode change pressing number (i.e., three times), a mode-change guidance message of “Please press a function selection key for a mode change” is detected in the data memory 122 and is voiced through the speaker 102 (S120).

After that, if the function selection key 110 is not pressed for a predetermined period (15 seconds), a cancel message (a snoring sound and the like) is voiced and then a current mode is converted into the sleep mode so as to reduce power consumption (S126). If the user presses the function selection key 110, the voice recognition unit 100 detects the pressing of the function selection key 110 to allow a mode- change guidance message of “record mode” to be voiced, and to allow a current mode to be converted into a record mode (S124).

As the current mode is converted into the record mode, the voice recognition unit 100 is converted to be in a record standby mode (S140). If the user presses the function selection key 110 for a short period once according to the voiced guidance message (S144), the voice recognition unit 100 senses the short-period pressing to allow a currently recorded voice message to be voiced (S146), and again returns to the record standby mode (S140). In case the function selection key 110 is not pressed for a predetermined period (S148), the voice recognition unit 100 is converted to be in the sleep mode (S152).

If the user presses the message key 112 for a long period, the voice recognition unit 100 senses the long-period pressing, converts a current mode thereof into a message record mode, stores the inputted voice message (S150), and converts the message record mode into the record standby mode (S140). If the function selection key 110 is not pressed for a predetermined period (S148), the voice recognition unit 100 converts a current mode thereof into the sleep mode (S152).

The user's voice message recorded through the voice message recording procedure is confirmed in a voice recognition mode.

In other words, if the user's voice command is inputted through the microphone 101 during a voice recognition standby mode (S132) in the voice recognition mode (S130), the voice recognition unit 100 recognizes the inputted voice command to allow the voice message stored in the data memory 122 to be voiced through the speaker 102 (S136), and returns to the voice recognition standby mode (S132).

After the voice message is voiced, if any voice command is not inputted for a predetermined time, the voice recognition unit 100 is converted to be in the sleep mode (S152)

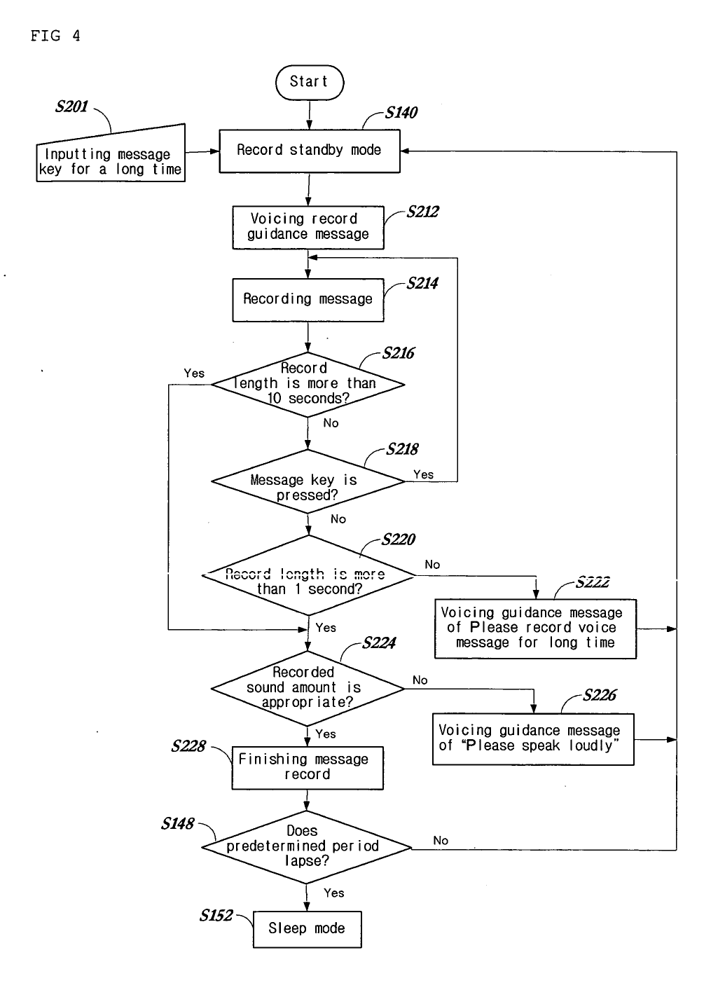

FIG. 4 is a detailed flowchart illustrating a voice message recording procedure of the voice message recording/playing procedure using the voice recognition according to a preferred embodiment of the present invention, and is a detailed flowchart of a voice message recording procedure (S150) in FIG. 3.

As illustrated in the drawings, as the message key 112 is pressed for a long period in the record standby mode (S140) of FIG. 3, the voice recognition unit 100 allows the recorded guidance message of “Please record a sentence of I love you, Tingdong” pre-stored in the code memory 121 to be voiced (S212)

After the user confirms the recorded guidance message, the voice message is recorded in a state of a pressed message key 112. After the recording is finished, the message key 112 is unpressed.

For a detailed description, the voice recognition unit 100 recognizes the voice message inputted through the microphone 101 in the state of the pressed message key 112 (S214). In case that a recording period is more than a predetermined period (one to 10 seconds) or 10 seconds as a result of voice recognition (S216), a sound amount of the voice message of till 10 seconds is checked to determine whether or not the sound amount is more than a predetermined sound amount (S224) . If the sound amount is more than the predetermined sound amount, the voice message is stored in a corresponding voice command address region allocated to the data memory 122 (S228).

In case that the recorded sound amount is less than the predetermined sound amount, the voice recognition unit 100 allows a guidance message of “Please again input loudly” to be voiced (S226), and then returns to the record standby mode (S140).

Further, in case that a user's message recording period is within a predetermined minimal period (one second), that is, in case that the message key 112 is pressed and then unpressed within one second (S218) (S220), the voice recognition unit 100 allows a guidance message of “Please record a voice message for a long period” to be voiced (S222), and then returns to the record standby mode (S140).

After the voice message is recorded as above, in case that the message key 112 for record is not pressed for a predetermined period (15 seconds), the voice recognition unit 100 finishes the message record mode and is converted to be in the sleep mode (S152).

In case that the inventive voice message recording/playing device is powered-on, or in case that the sleep mode is converted into the voice recognition mode or the record mode, a greeting message is voiced through the speaker.

Even when the above greeting message is recorded, the greeting message is recorded through the same recording procedure. That is, in case that the function selection key 110 is pressed at three times, the voice recognition unit 100 allows a guidance message of “Press a function selection key once for a mode change” to be detected from the code memory 121, and the detected guidance message to be voiced.

If the user presses the function selection key 110 once according to a guidance of the guidance message, the voice recognition unit 100 is converted to be in the record mode. The user continues to press the function selection key 110 for selection until a guidance message of “greeting words” is voiced.

If the guidance message of “greeting words” is voiced, the user presses the message key 112 to allow the. voice message corresponding to the greeting words to be recorded.

In other words, in case that the user presses the message key 112 for the predetermined time, the voice recognition unit 100 senses the pressed message key 112 and detects a guidance message of “Please record greeting words, Tingdong” from the code memory 121 to allow the detected guidance message to be voiced, and then is converted to be in the message record mode.

The voice recognition unit 100 recognizes the voice message inputted through the microphone 101 in the state of the pressed message key 112 to store the recognized voice message in a greeting message region of the data memory 122. At this time, the voice recognition unit 100 lights the LED display unit 103 to display the most appropriate time at which the voice message is inputted.

After that, only when the power-off system is powered-on or the system is activated from the sleep mode, the greeting message stored through the above procedure is voiced.

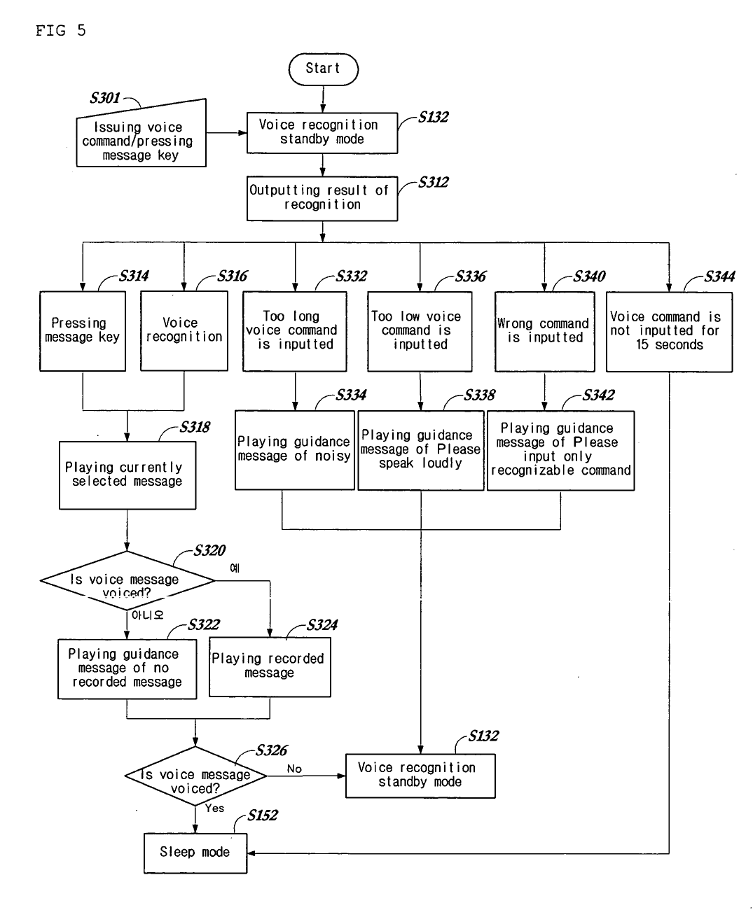

FIG. 5 is a detailed flowchart illustrating a voice message playing procedure in the voice message recording/playing method using the voice recognition according to a preferred embodiment of the present invention, and is a detailed flowchart illustrating the result of the voice recognition and the voice message playing procedure (S136) in FIG. 3.

As illustrated in the drawings, if the message key 112 is pressed or the voice command is inputted through the microphone 101 during the voice recognition standby mode (S132) of FGI. 3, the voice recognition unit 100 allows the voice message corresponding to the message key 112 or the voice command to be voiced (S312 to S318).

Herein, in order for the user to input the voice command, the voice recognition unit 100 lights the LED display unit 103 to allow the user to confirm an exact time at which the voice command can be inputted.

In case that the voice message corresponding to the voice command does not exist in the data memory 122 (S320), the voice recognition unit 100 allows a guidance message of “No recorded voice message” to be voiced (S322), and then returns to the voice recognition standby mode (S132). In case that the pre-stored corresponding voice message does exist (S324), the voice recognition unit 100 allows the voice message to be voiced through the speaker 102 (S236), and then returns to the sleep mode (S152).

Meanwhile, in case that the voice message is not voiced, the voice recognition unit 100 returns to the voice recognition standby mode (S132).

If the voice command is inputted for a longer period than a predetermined period (S332) as a result of the voice recognition for the voice command inputted to the voice recognition unit 100 (S312), it is determined that an environmental noise is heavy such that the voice recognition unit 100 allows a guidance message of “noisy” to be voiced (S334) and then returns to the voice recognition standby mode (S132).

Further, if the sound amount of the voice command is less than the predetermined sound amount (S336) as the result of the voice recognition for the voice command inputted to the voice recognition unit 100 (S312), the voice recognition unit 100 allows a guidance message of “Please speak loudly” to be voiced (S336), and then returns to the voice recognition standby mode (S132).

Furthermore, if the voice command is not the pre-stored voice command (S340) as the result of the voice recognition for the voice command inputted to the voice recognition unit 100 (S312), the voice recognition unit 100 allows a guidance message of “Please input only a recognizable voice command” to be voiced (S342), and then returns to the voice recognition standby mode (S132).

Additionally, in case that any voice command is not inputted to the voice recognition unit 100 or in case that any message key 112 is not pressed in the voice recognition standby mode (S132), the voice recognition unit 100 allows a guidance message of “sleep mode” to be voiced after 15 seconds (S344), and then is converted to be in the sleep mode (S152).

As described above, the voice message recording/playing method using the voice recognition according to the present invention has an effect in that since the user can directly change and store the voice message, and the voice command can be recognized to allow the corresponding stored voice message to be voiced, the user can listen to the voice message using only a simple voice command. Further, the present invention has an effect in that in case that the voice message is not recorded or not voiced, the user can exactly and easily confirm the corresponding cause through the guidance message.

It will be apparent to those skilled in the art that various modifications and variations can be made in the present invention. Thus, it is intended that the present invention covers the modifications and variations of this invention provided they come within the scope of the appended claims and their equivalents.

1. A voice message recording/playing method using voice recognition in which if a user's voice command is inputted through a microphone in a voice recognition mode selected by a function selection key, voice is recognized and then a preset command is performed correspondingly to the inputted voice command, the method comprising the steps of:
selecting one of preset modes as the function selection key is pressed;
if a system is in a system-on state in the mode selecting step, sequentially issuing a voice command whenever the function selection key is pressed;
if a record mode is selected in the mode selecting step, recording a user's voice message corresponding to a pre-stored voice command in a data memory according to a guidance message;
if a voice recognition standby mode is selected in the mode selecting step, recognizing the inputted user's voice command to detect a corresponding voice message from the data memory and voice the detected voice message through a speaker; and
if the voice command is not inputted for a predetermined period after the function selection key is pressed, voicing a guidance message and concurrently, converting a current mode into a sleep mode.

2. The method according to claim 1, wherein in the mode selecting step, times of pressing the function selection key are detected to determine a mode selection.

3. The method according to claim 1, wherein the mode selecting step comprises the step of if the function selection key is pressed, voicing a mode-change guidance message and voicing a selected-mode guidance message.

4. The method according to claim 1, wherein the recording step comprises:
a first step of if the message key is pressed for record in a record standby mode, recording a voice message according to a record guidance message;
a second step of if a length and a sound amount of the inputted voice message is not within a predetermined range, voicing a guidance message requesting a user to again input; and
a third step of if the length and the sound amount of the inputted voice message is within the predetermined range, storing the voice message in the data memory.

5. The method according to claim 4, wherein the first step further comprises the step of lighting a LED display unit to display a period for which the user inputs the voice message for record.

6. The method according to claim 4, wherein the voice message recording step comprises the step of executing a message record mode or a recorded-message play mode depending on a period for which the message key is pressed.

7. The method according to claim 1, wherein the voice recognizing/voicing step comprises:
a first step of recognizing the user's voice command in the voice recognition standby mode to detect and voice a corresponding voice message from the data memory, and returning to the voice recognition standby mode;
a second step of if a length and a sound amount of the voice command is not within a recognition range as a result of user's voice recognition, voicing a guidance message for the recognition result and then returning to the voice recognition standby mode; and
a third step of if the voice command is not a pre-stored command as a result of the user's voice recognition, voicing a corresponding guidance message and then returning to the voice recognition standby mode.

8. The method according to claim 7, wherein the first step further comprises the step of lighting the LED display unit to display a period for which the user inputs the voice command, for the voice recognition.

9. The method according to claim 7, further comprising the step of if the message key is pressed in the voice recognition standby mode, voicing the voice message stored in the data memory.

10. The method according to claim 7, further comprising the step of if the voice command is not inputted for a predetermined period in the voice recognition standby mode, voicing a guidance message for conversion into a sleep mode and then converting the voice recognition standby mode into the sleep mode.

11. The method according to claim 7, further comprising the step of if a voice command of conversion into the sleep mode is inputted in the voice recognition standby mode, voicing a corresponding voice message and then converting the voice recognition standby mode into the sleep mode.
